(19) United States
(12) Patent Application Publication
(10) Pub. No.: US 2005/0062918 A1
(43) Pub. Date: Mar. 24, 2005

(54) Liquid crystal display device

(76) Inventors: Naru Usukura, Tenri-shi (JP); Kanae Suenaga, Osaka-shi (JP); Takayuki Natsume, Tenri-shi (JP)

Correspondence Address: EDWARDS & ANGELL, LLP, P.O. BOX 55874, BOSTON, MA, 02205, US

(21) Appl. No.: 10/943,410

(22) Filed: Sep. 17, 2004

(30) Foreign Application Priority Data
Sep. 18, 2003 (JP) 2003-326531

(51) Int. Cl. G02F 1/1335

(52) U.S. Cl. 349/121

(57) ABSTRACT

A liquid crystal display device of the present invention includes: a liquid crystal layer; a first substrate and a second substrate opposing each other with the liquid crystal layer being interposed therebetween; a reflection layer provided on one side of the liquid crystal layer that is closer to the first substrate; a polarizer provided on one side of the liquid crystal layer that is closer to the second substrate; a phase compensator provided between the liquid crystal layer and the polarizer and having a slow axis within a plane parallel to the liquid crystal layer; and at least a pair of electrodes for applying a voltage across the liquid crystal layer. The liquid crystal display device of the present invention includes a reflection region in which a display is produced by using light that enters the device from one side of the device that is closer to the second substrate, passes through the polarizer, the phase compensator and the liquid crystal layer in this order and is reflected by the reflection layer. The slow axis SL of the phase compensator is inclined from the direction D1 that is at an angle of 45° with respect to the transmission axis TR of the polarizer.

### FIELD OF THE INVENTION

The present invention relates to a liquid crystal display device, and more particularly to a liquid crystal display device capable of displaying an image in a reflection mode.

### BACKGROUND OF THE INVENTION

Liquid crystal display devices are widely used as displays of PDAs (personal digital assistants) for their advantageous features such as light weight, thin structure and small power consumption. Among other types of liquid crystal display devices, reflective and transflective liquid crystal display devices are capable of displaying an image using the ambient light reflected by a reflection layer on the back of the liquid crystal layer (reflection mode display). Therefore, it is possible to eliminate or reduce the use of a backlight, which is indispensable in a transmissive liquid crystal display device, thereby further reducing the power consumption.

A reflective liquid crystal display device 300 as illustrated in FIG. 21 has been known in the art. The reflective liquid crystal display device 300 includes a phase plate 320 and a polarization plate 330 on the viewer side of a liquid crystal cell 310. The liquid crystal cell 310 includes a liquid crystal layer 308 having a homogeneous orientation between a pair of substrates 301 and 302, and a reflection electrode 303 and a transparent electrode 305 for applying a voltage across the liquid crystal layer 308.

Linearly-polarized light, having passed through the polarization plate 330, passes through the phase plate (e.g., a λ/4 plate) 320 and the liquid crystal layer 308, where it is given a retardation (a quantity given in length, obtained by converting a phase difference to a wavelength). The value of the retardation is dependent on the retardation of the phase plate 320 and the retardation of the liquid crystal layer 308. It is represented as the product (Δn·d) of the birefringence Δn of the liquid crystal layer 308 and the thickness d thereof (also referred to as the “cell gap”), and varies as the birefringence (Δn) varies due to a change in the orientation of liquid crystal molecules. Therefore, by controlling the applied voltage and thus controlling the retardation of the liquid crystal-layer 308, it is possible to control the retardation to be given to light that passes through the polarization plate 330, the phase plate 320 and the liquid crystal layer 308 and is then reflected by the reflection electrode 303 to pass again through the liquid crystal layer 308 and the phase plate 320. Thus, by controlling the applied voltage, it is possible to control the amount of light that passes through the polarization plate 330 and is then reflected by the reflection electrode 303 to pass again through the polarization plate 330, thereby realizing a gray-scale display.

However, even if the retardation of the phase plate 320 and that of the liquid crystal layer 308 are optimally designed for a white or black display for a particular wavelength (e.g., for a wavelength of 550 nm in the visible wavelength range of 400 nm to 700 nm, at which light has the highest visibility), the retardations will shift from the optimal design values at other wavelengths because the retardations of the phase plate 320 and the liquid crystal layer 308 have wavelength dispersion, whereby light leakage and coloring will be significant particularly in a black display, resulting in a substantial decrease in the display quality.

In view of this, Japanese Laid-Open Patent Publication No. 2001-356336 discloses a liquid crystal display device that produces a black display in a state where the retardation of the liquid crystal layer is small and that uses a phase compensator whose retardation monotonically increases as the wavelength λ of light increases, thereby improving the black display quality. Japanese Laid-Open Patent Publication No. 2001-356336 discloses a phase compensator being a single phase plate of diacetyl cellulose, and a laminated phase compensator obtained by laminating together two phase plates of polyvinyl alcohol.

Where a single phase plate is used, the phase plate is arranged so that the angle between the transmission axis of the polarization plate and the slow axis of the phase plate is 45°, and the slow axis of the phase plate is perpendicular or parallel to the average orientation direction of the liquid crystal molecules in the liquid crystal layer (the azimuthal direction in the middle between the orientation direction of liquid crystal molecules near the upper surface and that of liquid crystal molecules near the lower surface), as illustrated in FIG. 22A and FIG. 22B. It has been believed in the art that a white display and a black display can be produced appropriately only with such an arrangement. Thus, the retardation of the phase plate and the wavelength dispersion thereof have been optimized in view of such an arrangement.

Japanese Laid-Open Patent Publication No. 10-68816 discloses a laminated phase compensator obtained by laminating together a λ/4 plate and a λ/2 plate so that the drawing axes thereof are at a suitable angle, thereby facilitating the control of the wavelength dispersion of the retardation.

### SUMMARY OF THE INVENTION

However, in-depth researches made by the present inventors revealed a problem with the arrangement using a single phase plate disclosed in Japanese Laid-Open Patent Publication No. 2001-356336. That is, even if the phase plate is arranged as described above, coloring cannot sufficiently be suppressed because there does not exist a material that realizes an ideal wavelength dispersion, whereby strong purple coloring occurs in an intermediate gray level display and in a black display.

With a laminated phase compensator as disclosed in Japanese Laid-Open Patent Publication Nos. 2001-356336 and 10-68816, it is relatively easy to realize a wavelength dispersion with which coloring can sufficiently be suppressed. However, the use of a plurality of phase plates increases the production cost.

It is therefore an object of this invention to provide a liquid crystal display device that can be produced at a low cost and in which coloring in a black display and in an intermediate gray level display is sufficiently suppressed.

An inventive liquid crystal display device includes: a liquid crystal layer; a first substrate and a second substrate opposing each other with the liquid crystal layer being interposed therebetween; a reflection layer provided on one side of the liquid crystal layer that is closer to the first substrate; a polarizer provided on one side of the liquid crystal layer that is closer to the second substrate; a phase compensator provided between the liquid crystal layer and the polarizer and having a slow axis within a plane parallel to the liquid crystal layer; and at least a pair of electrodes for applying a voltage across the liquid crystal layer, wherein: the liquid crystal display device includes a reflection region in which a display is produced by using light that enters the device from one side of the device that is closer to the second substrate, passes through the polarizer, the phase compensator and the liquid crystal layer in this order and is reflected by the reflection layer; and the slow axis of the phase compensator is inclined from a direction that is at an angle of 45° with respect to a transmission axis of the polarizer.

In a preferred embodiment, the liquid crystal display device includes no phase compensator other than the phase compensator.

In a preferred embodiment, the phase compensator is a single phase plate.

In a preferred embodiment, the slow axis of the phase compensator is inclined from a direction that is defined by an azimuthal angle of an orientation direction of liquid crystal molecules present around a center of the liquid crystal layer in a thickness direction thereof.

In a preferred embodiment, an angle θ between the slow axis of the phase compensator and an absorption axis of the polarizer satisfies 20° [symbol] θ [symbol] 40°.

In a preferred embodiment, an in-plane retardation Re(λ) of the phase compensator for light having a wavelength of λ (nm) satisfies 98 nm≦Re(450)≦158 nm, 140 nm≦Re(550)≦175 nm and 141 nm≦Re(650)≦210 nm.

In a preferred embodiment, an in-plane retardation Re(λ) of the phase compensator for light having a wavelength of λ (nm) satisfies 0.7 [symbol] Re(450)/Re(550) [symbol] 0.9 and 1.01<Re(650)/Re(550)<1.2.

In a preferred embodiment, an in-plane retardation Re(λ) of the phase compensator for light having a wavelength of λ (nm) increases monotonically as λ increases over a range of 400 nm≦λ≦700 nm.

Another inventive liquid crystal display device includes: a liquid crystal layer; a first substrate and a second substrate opposing each other with the liquid crystal layer being interposed therebetween; a reflection layer provided on one side of the liquid crystal layer that is closer to the first substrate; a polarizer provided on one side of the liquid crystal layer that is closer to the second substrate; a phase compensator provided between the liquid crystal layer and the polarizer; and at least a pair of electrodes for applying a voltage across the liquid crystal layer, wherein: the liquid crystal display device includes a reflection region in which a display is produced by using light that enters the device from one side of the device that is closer to the second substrate, passes through the polarizer, the phase compensator and the liquid crystal layer in this order and is reflected by the reflection layer; and the phase compensator rotates, on a Poincare sphere, linearly-polarized light, having entered the device from one side of the device that is closer to the second substrate and passed through the polarizer, about a rotation axis inclined from a straight line including a point on the Poincare sphere representing the linearly-polarized light and a center of the Poincare sphere.

In a preferred embodiment, an angle θ′ between the rotation axis and the straight line satisfies 40° [symbol] θ′ [symbol] 80°.

In a preferred embodiment, a retardation Δn·d defined as a product of a birefringence Δn of the liquid crystal layer and a thickness d of the liquid crystal layer in the reflection region varies over a range of Δn₁·d≦Δn·d≦Δn₂·d according to a value of a voltage applied between the pair of electrodes, where a black display is produced when Δn·d=Δn₁·d.

In a preferred embodiment, a color difference ΔE*ab in an L*a*b* color system between light from standard illuminant D65 and light being output from the polarizer toward a viewer after being reflected by the reflection layer is 5 or less.

In the liquid crystal display device of the present invention, the slow axis of the phase plate within a plane parallel to the liquid crystal layer is inclined from (neither parallel nor perpendicular to) a direction that is at an angle of 45° with respect to the transmission axis of the polarization plate, whereby it is possible to reduce variations in the optical transmittance for different wavelengths. Therefore, it is possible to suppress coloring in a black display and in an intermediate gray level display and to realize a high-quality display. Moreover, the liquid crystal display device does not require a plurality of phase plates of different types (differing from one another in terms of the retardation settings and the arrangement of the slow axis), thus realizing a reduction in the production cost.

Thus, the present invention provides a liquid crystal display device that can be produced at a low cost and in which coloring in a black display and in an intermediate gray level display is sufficiently suppressed.

### BRIEF DESCRIPTION OF THE DRAWINGS

FIG. 1 is a cross-sectional view schematically illustrating a reflective liquid crystal display device of the present invention.

FIG. 2 schematically shows an arrangement of a phase plate and a polarization plate used in a reflective liquid crystal display device of the present invention.

FIG. 3 is a graph showing the wavelength dispersion characteristics (wavelength dependence) curve of the retardation of a liquid crystal layer in a white display.

FIG. 4 is a graph showing the wavelength dispersion characteristics (wavelength dependence) curve of the retardation of a phase plate.

FIG. 5 shows a Poincare sphere.

FIG. 6 shows the function of a phase plate in a conventional arrangement.

FIG. 7 shows the relationship between the transmittance and the distance (deviation) from a point on the Poincare sphere in the azimuthal direction of the transmission axis of a polarization plate.

FIG. 8 shows how the polarization of incident light changes in a conventional arrangement.

FIG. 9 shows how the polarization of incident light changes in a reflective liquid crystal display device of the present invention.

FIG. 10 shows an exemplary arrangement of the slow axis of the phase plate, the absorption axis of the polarization plate and the average orientation direction of the liquid crystal layer in a reflective liquid crystal display device of the present invention.

FIG. 11 shows how the polarization of incident light changes in a black display with the arrangement shown in FIG. 10.

FIG. 12 shows how the polarization of incident light changes in an intermediate gray level display with the arrangement shown in FIG. 10.

FIG. 13 shows how the polarization of incident light changes in a white display with the arrangement shown in FIG. 10.

FIG. 14 shows how the polarization of incident light changes in a black display in a comparative example where the slow axis of the phase plate and the average orientation direction of the liquid crystal layer are parallel to each other.

FIG. 15 shows how the polarization of incident light changes in an intermediate gray level display in a comparative example where the slow axis of the phase plate and the average orientation direction of the liquid crystal layer are parallel to each other.

FIG. 16 shows how the polarization of incident light changes in a white display in a comparative example where the slow axis of the phase plate and the average orientation direction of the liquid crystal layer are parallel to each other.

FIG. 17 shows how the polarization of incident light changes in a black display in a comparative example where the slow axis of the phase plate and the average orientation direction of the liquid crystal layer are perpendicular to each other.

FIG. 18 shows how the polarization of incident light changes in an intermediate gray level display in a comparative example where the slow axis of the phase plate and the average orientation direction of the liquid crystal layer are perpendicular to each other.

FIG. 19 shows how the polarization of incident light changes in a white display in a comparative example where the slow axis of the phase plate and the average orientation direction of the liquid crystal layer are perpendicular to each other.

FIG. 20 is a graph showing the color difference ΔE*ab in the L*a*b* color system between light output from a reflective liquid crystal display device of the present invention and standard illuminant D65.

FIG. 21 is a cross-sectional view schematically illustrating a conventional reflective liquid crystal display device.

FIG. 22A and FIG. 22B each schematically shows an arrangement of the slow axis of the phase plate in a conventional reflective liquid crystal display device.

### DESCRIPTION OF THE PREFERRED EMBODIMENTS

An embodiment of the present invention will now be described with reference to the drawings. While the following embodiment of the present invention is directed to a reflective liquid crystal display device, the present invention is not limited thereto, but can widely be used in various liquid crystal display devices in which each pixel region corresponding to the minimum unit of display includes a reflection region where a display is produced in a reflection mode. For example, the present invention can be used in a transflective liquid crystal display device or a semi-transmissive liquid crystal display device using a semi-transmissive film (half mirror). In the reflective liquid crystal display device illustrated herein, the design of the retardation of the phase plate, the arrangement of the slow axis of the phase plate, etc., are different from those in conventional devices. Otherwise, structures known in the art can widely be used. Moreover, as long as the polarization plate, the phase plate, the liquid crystal layer and the reflection layer are arranged in this order from the viewer side, there are no limitations as to where these members are located with respect to the substrate.

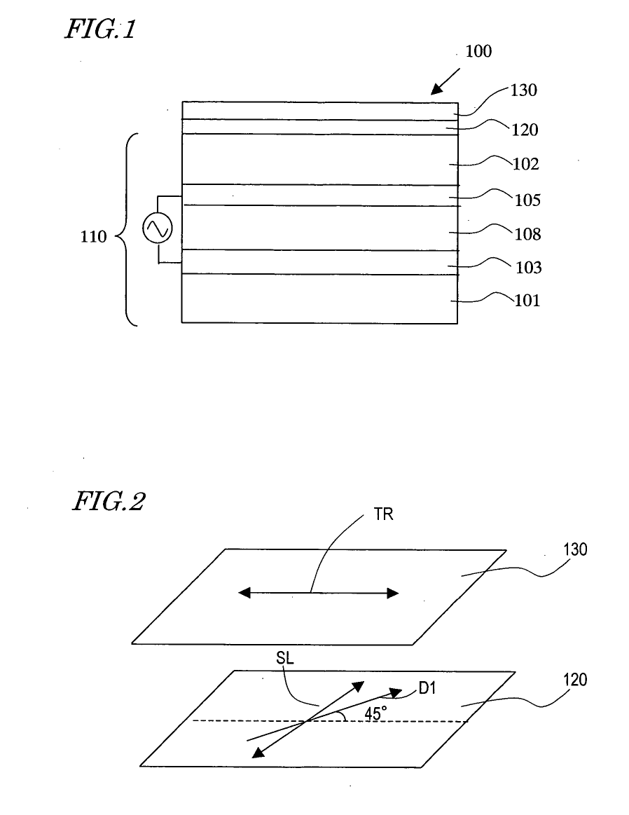

FIG. 1 schematically illustrates a reflective liquid crystal display device 100 of the present embodiment. The reflective liquid crystal display device 100 includes a liquid crystal cell 110, and a phase plate 120 and a polarization plate 130, which are provided on the viewer side of the liquid crystal cell 110. The liquid crystal cell 110 includes a pair of substrates (e.g., glass substrates) 101 and 102 opposing each other, a liquid crystal layer 108 provided therebetween, and a reflection electrode (e.g., an Al layer) 103 and a transparent electrode (e.g., an ITO layer) 105 for applying a voltage across the liquid crystal layer 108. The reflective liquid crystal display device 100 produces a display by using light that enters the device from one side of the device (the viewer side) that is closer to the substrate 102, passes through the polarization plate 130, the phase plate 120 and the liquid crystal layer 108 in this order, and is reflected by the reflection electrode 103.

In the reflective liquid crystal display device 100, the retardation Δn·d, which is defined as the product of the birefringence Δn of the liquid crystal layer 108 and the thickness d of the liquid crystal layer 108, varies over the range of Δn₁·d≦Δn·d≦Δn₂·d according to the value of the voltage applied between the reflection electrode 103 and the transparent electrode 105, where a black display is produced when Δn·d=Δn₁·d. Thus, the reflective liquid crystal display device 100 produces a black display when the retardation of the liquid crystal layer 108 is small.

A configuration where a black display is produced when the retardation of the liquid crystal layer 108 is small is more advantageous in terms of productivity than a configuration where a black display is produced when the retardation of the liquid crystal layer 108 is large (i.e., when Δn·d=Δn₂·d). In a configuration where a black display is produced when the retardation of the liquid crystal layer 108 is large, if the thickness d (cell gap) of the liquid crystal layer 108 deviates from the design value, the retardation of the liquid crystal layer 108 in a black display will deviate significantly from the design value (because Δn₂>Δn₁), whereby light will not be blocked sufficiently in a black display, thus failing to obtain a sufficient contrast. Therefore, in order to produce a desirable black display, it is necessary to control the cell gap with a high precision, thereby leaving little margin in the production process, resulting in a poor productivity. In contrast, with a configuration where a black display is produced when the retardation of the liquid crystal layer 108 is small, the deterioration in the display quality is small with respect to variations in the cell gap (the thickness of the liquid crystal layer 108), and the configuration is advantageous in terms of productivity.

A configuration where a black display is produced when the retardation of the liquid crystal layer 108 is small may be, for example, a normally white (NW) mode using a liquid crystal material having a positive dielectric anisotropy, or a normally black (NB) mode using a liquid crystal material having a negative dielectric anisotropy. The reflective liquid crystal display device 100 of the present embodiment produces a display in a normally white mode using a liquid crystal material having a positive dielectric anisotropy.

Next, the phase plate 120 of the reflective liquid crystal display device 100 will be described with reference to FIG. 2. As shown in FIG. 2, the phase plate 120 has its slow axis SL within a plane parallel to the liquid crystal layer 108. The slow axis SL of the phase plate 120 is inclined with respect to the direction D1 that is at an angle of 45° with respect to the transmission axis TR of the polarization plate 130. Thus, the slow axis SL of the phase plate 120 is neither parallel nor perpendicular to the direction D1, and is not at an angle of 45° with respect to the transmission axis TR of the polarization plate 130.

In the reflective liquid crystal display device 100 of the present invention, the slow axis SL of the phase plate 120 is arranged as described above, whereby it is possible to suppress coloring in a black display and in an intermediate gray level display and to realize a high-quality display. The reason for is as follows.

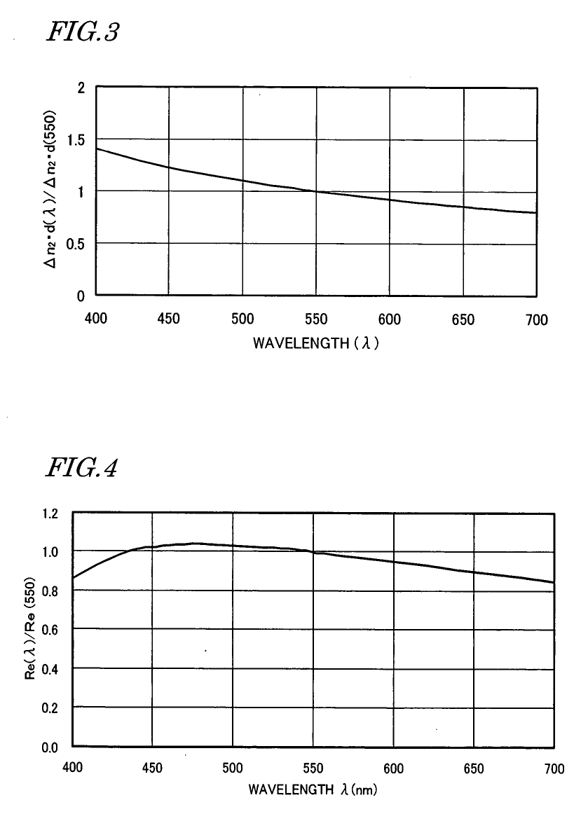

Linearly-polarized light, having entered the device from the viewer side and passed through the polarization plate 130, passes through the phase plate 120 and the liquid crystal layer 108, where it is given a retardation, and the value of the retardation is dependent on the retardation of the phase plate 120 and the retardation of the liquid crystal layer 108. FIG. 3 and FIG. 4 show exemplary wavelength dispersion characteristics (wavelength dependence) curve of the retardation Δn₂·d of the liquid crystal layer 108 in a white display, and that of the retardation Re of the phase plate 120, respectively. Note that the vertical axis in FIG. 3 represents the retardation Δn₂·d(λ) for light having a wavelength of λ (nm), normalized with the retardation Δn₂·d(550) for light having a wavelength of 550 nm. Similarly, the vertical axis in FIG. 4 represents the retardation Re(λ) for light having a wavelength of λ (nm), normalized with the retardation Re(550) for light having a wavelength of 550 nm.

The retardation Δn₂·d of the liquid crystal layer 108 shows wavelength dependence such that the retardation decreases monotonically as the wavelength λ increases, as shown in FIG. 3, for example. The retardation Re of the phase plate 120 shows wavelength dependence such that the retardation once increases and then decreases as the wavelength λ increases, as shown in FIG. 4, for example.

The retardation Δn₁·d of the liquid crystal layer 108 in a black display is preferably close to zero. In practice, however, there will be a small retardation in a black display due to the anchoring effect from a surface that has been subjected to a rubbing treatment (typically, the surface of an alignment film). The retardation is called “residual retardation”.

Typically, a desirable black display without coloring can be obtained if the total retardation including the residual retardation Δn₁·d of the liquid crystal layer 108 and the retardation Re of the phase plate is λ/4 for all visible light wavelengths. Note however that since the residual retardation Δn₁·d of the liquid crystal layer 108 is significantly smaller than the retardation ΔRe of the phase plate 120, the display quality in a black display is dominantly influenced by the wavelength dependence of the retardation ΔRe of the phase plate 120. Therefore, it is possible to produce a black display in which coloring is sufficiently suppressed if the retardation ΔRe of the phase plate 120 is substantially λ/4 for all visible light wavelengths. In practice, however, a phase plate material realizing such ideal wavelength dependence does not exist, and a desirable black display cannot be produced only by optimizing the wavelength dependence of the retardation ΔRe of the phase plate 120. Note that in the conventional arrangements illustrated in FIG. 22A and FIG. 22B, the total retardation including the residual retardation Δn₁·d of the liquid crystal layer 108 and the retardation Re of the phase plate can be expressed as a simple arithmetic sum (or difference) between the residual retardation Δn₁·d of the liquid crystal layer 108 and the retardation Re of the phase plate, whereby it is relatively easy to appropriately design the retardation Re of the phase plate, which is believed to be one reason that such arrangements as illustrated in FIG. 22A and FIG. 22B have been used in the art.

In the reflective liquid crystal display device 100 of the present invention, the arrangement of the slow axis of the phase plate 120 and the transmission axis of the polarization plate 130 is different from that of conventional devices, thereby realizing a high-quality black display and a high-quality intermediate gray level display.

Now, the difference between the function of the phase plate in a conventional arrangement and that in the reflective liquid crystal display device 100 will be described by using a “Poincare sphere” with reference to FIG. 5 to FIG. 9.

As shown in FIG. 5, a “Poincare sphere” is a sphere defined by Stokes parameters S₀, S₁, S₂ and S₃ representing the polarization of light. The parameters S₁, S₂ and S₃ respectively correspond to different axes in a rectangular coordinate system (the x axis, the y axis and the z axis, respectively, in FIG. 5), and the parameter S₀ (intensity) is the radius of the sphere. The polarization of light is represented as a point on the spherical surface of the Poincare sphere.

Comparing the Poincare sphere to the globe, since the latitude represents a value twice the ellipticity angle, light having an ellipticity angle of zero, i.e., linearly-polarized light, is plotted along the equator, circularly-polarized light at the South Pole or the North Pole, and elliptically-polarized light between the equator and the Poles. Right-handed polarized light is plotted on the northern hemisphere, and left-handed polarized light is plotted on the southern hemisphere. A point at the North Pole represents right-handed circularly-polarized light, and a point at the South Pole represents left-handed circularly-polarized light. Moreover, since the longitude represents a value twice the azimuthal angle of the ellipse major axis, where the longitude is assumed to be zero at one of the intersections between the Poincare sphere and the x axis on the positive side (one that is closer to the arrow head), the positive-side intersection represents linearly-polarized light that oscillates in the horizontal direction, and the negative-side intersection between the Poincare sphere and the x axis (one that is closer to the arrow tail) represents linearly-polarized light that oscillates in the vertical direction. Moreover, the positive-side intersection between the Poincare sphere and the y axis represents linearly-polarized light that oscillates in the 45° direction (a direction shifted by 45° counterclockwise from the horizontal direction), and the negative-side intersection between the Poincare sphere and the y axis represents linearly-polarized light that oscillates in the −45° direction (a direction shifted by 45° clockwise from the horizontal direction).

The function of a phase plate on the Poincare sphere is to rotate polarized light represented by a point on the Poincare sphere by a predetermined angle about a certain rotation axis passing through the center of the Poincare sphere. The angle of rotation is dependent on the value of the retardation of the phase plate, and the rotation axis is defined as a straight line connecting the center of the Poincare sphere with a point along the equator at a longitude corresponding to a value twice the azimuthal angle of the slow axis of the phase plate.

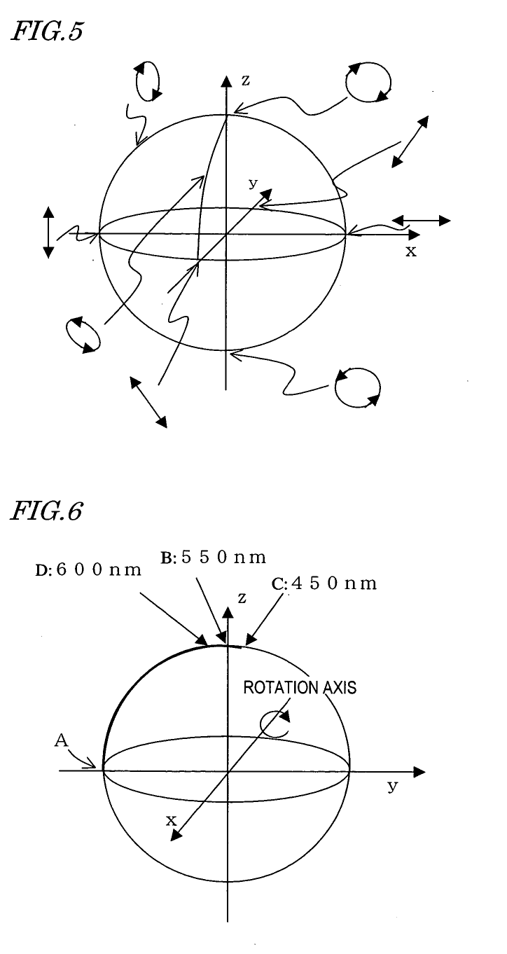

FIG. 6 shows the function of a phase plate in a conventional liquid crystal display device, i.e., in an arrangement where the transmission axis of the polarization plate and the slow axis of the phase plate are at an angle of 45°. The retardation Re of the phase plate being used in this arrangement has wavelength dependence as shown in FIG. 4, and the phase plate is designed so as to satisfy the λ/4 condition for light having a wavelength of 550 nm. Where linearly-polarized light having entered the device from the viewer side and passed through the polarization plate corresponds to the negative-side intersection A between the Poincare sphere and the y axis, the phase plate whose slow axis is at an angle of 45° with respect to the transmission axis of the polarization plate rotates this linearly-polarized light about the x axis. Since the phase plate satisfies the λ/4 condition for light having a wavelength of 550 nm, linearly-polarized light represented by point A that has a wavelength of 550 nm is rotated by just 90° about the x axis so as to be converted to right-handed circularly-polarized light represented by point B at the North Pole. However, the phase plate does not always satisfy the λ/4 condition for wavelengths shorter or longer than 550 nm, whereby light having a wavelength of 450 nm or light having a wavelength of 600 nm is rotated by an angle greater or less than 90° so as to be converted to elliptically-polarized light represented by point C or point D, which are deviated from point B at the North Pole.

In order to produce a desirable black display and a desirable white display, it is necessary that linearly-polarized light being incident on the phase plate after passing through the polarization plate is converted, by the time it is incident on the polarization plate after being reflected by the reflection layer, to linearly-polarized light whose polarization direction is perpendicular (in a black display) or parallel (in a white display) to the original polarization direction for the design wavelength, and it is preferred that for other wavelengths, substantially the same transmittance as that for the design wavelength is exhibited. Also in an intermediate gray level display, it is preferred that substantially the same transmittance is exhibited for all (visible light) wavelengths including the design wavelength.

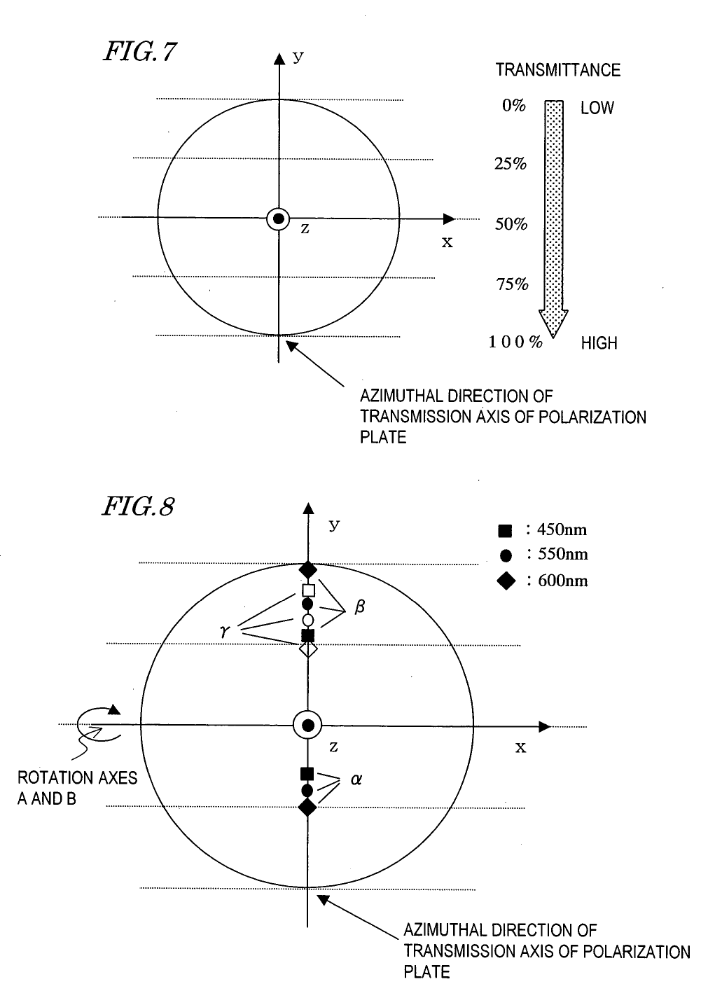

As shown in FIG. 7, on a Poincare sphere, the transmittance exhibited when light of a certain polarization passes through the polarization plate is dependent on the “distance” between the point representing the light and a point corresponding to the azimuthal direction of the transmission axis of the polarization plate (which coincides with the point representing linearly-polarized light having entered the device from the viewer side and passed through the polarization plate). Note that this “distance” is not a simple distance between two points, but is a “deviation” therebetween in a direction along a straight line between the point corresponding to the azimuthal direction of the transmission axis of the polarization plate and the center of the Poincare sphere (a direction along the y axis in the illustrated example).

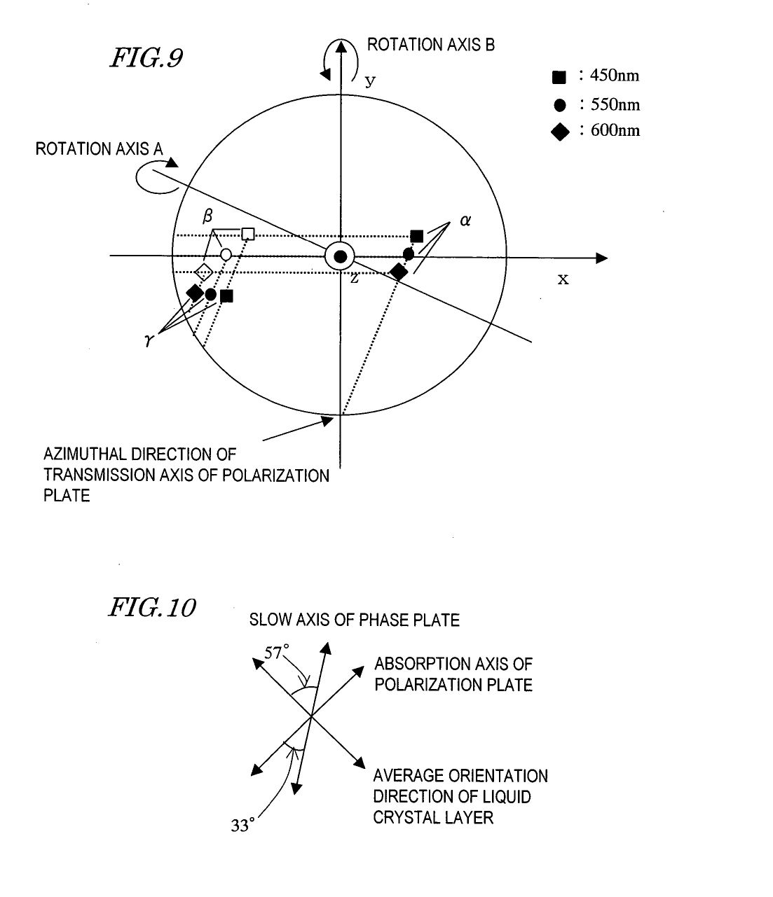

FIG. 8 shows how the polarization changes when linearly-polarized light, having entered the device from the viewer side and passed through the polarization plate, passes through the phase plate, the liquid crystal layer and the phase plate in this order in a conventional arrangement. FIG. 9 shows how the polarization changes when linearly-polarized light, having entered the device from the viewer side and passed through the polarization plate 130, passes through the phase plate 120, the liquid crystal layer 108 and the phase plate 120 in this order in the reflective liquid crystal display device 100 of the present embodiment. Note that in FIG. 8 and FIG. 9, the rotation axis A represents the axis of rotation by the phase plate, and the rotation axis B represents the axis of rotation by the liquid crystal layer. Moreover, “α” denotes light after passing through the phase plate for the first time, “β” denotes light after passing through the liquid crystal layer, and “γ” denotes light after passing through the phase plate again. Moreover, each solid symbol denotes light on the northern hemisphere of the Poincare sphere, while each open symbol denotes light on the southern hemisphere of the Poincare sphere.

In a conventional arrangement where the slow axis of the phase plate is at an angle of 45° with respect to the transmission axis of the polarization plate, the axis A of rotation by the phase plate (which coincides with the x axis) is perpendicular to the straight line (which coincides with the y axis) including the point representing the azimuthal direction of the transmission axis of the polarization plate and the center of the Poincare sphere, as shown in FIG. 8. Therefore, a deviation in the angle of rotation due to, the wavelength dependence of the retardation of the phase plate is more likely reflected in the “deviation” in the direction along the y axis. Thus, the optical transmittance varies more significantly for different wavelengths, whereby coloring is more likely to occur in the display. Particularly, strong coloring occurs in an intermediate gray level display.

In contrast, in the reflective liquid crystal display device 100, the slow axis of the phase plate 120 is inclined from (neither parallel nor perpendicular to) a direction that is at an angle of 45° with respect to the transmission axis of the polarization plate 130, whereby the axis A of rotation by the phase plate 120 is inclined from (neither parallel nor perpendicular to) the straight line (which coincides with the y axis) including the point representing the azimuthal direction of the transmission axis of the polarization plate 130 and the center of the Poincare sphere, as shown in FIG. 9. Thus, on the Poincare sphere, the phase plate 120 of the reflective liquid crystal display device 100 rotates linearly-polarized light, having entered the device from the viewer side and passed through the polarization plate 130, about the rotation axis (the axis A in the illustrated example), which is inclined from the straight line (the y axis in the illustrated example) including the point representing the linearly-polarized light and the center of the Poincare sphere. Therefore, a deviation in the angle of rotation due to the wavelength dependence of the retardation of the phase plate 120 is less likely reflected in the “deviation” in the direction along the y axis (the straight lin e including the point representing the incident linearly-polarized light and the center of the Poincare sphere), resulting in less significant variations in the optical transmittance for different wavelengths. Thus, it is possible to suppress coloring in a black display and in an intermediate gray level display, thereby realizing a high-quality display.

Moreover, the reflective liquid crystal display device 100 does not require a plurality of phase plates of different types (differing from one another in terms of the retardation settings and the arrangement of the slow axis), thus realizing a reduction in the production cost. Note that while the single-sheet phase plate 120 is used as the phase compensator in the present embodiment, the phase compensator does not have to be an integrated, single phase plate. As long as the phase compensator provided between the liquid crystal layer 108 and the polarization plate 130 defines a single slow axis within a plane parallel to the liquid crystal layer 108, coloring can be suppressed by arranging the slow axis as described above. Nevertheless, it is preferred to use a single phase plate in view of the production cost.

Advantageous effects can be obtained as described above if the slow axis of the phase plate 120 is inclined from a direction that is at an angle of 45° with respect to the transmission axis of the polarization plate 130. As a result of further in-depth researches, the present inventors have found that the advantageous effects can be obtained more reliably if the angle θ between the slow axis of the phase plate 120 and the absorption axis of the polarization plate 130 (typically perpendicular to the transmission axis) satisfies 20° [symbol] θ [symbol] 40°, i.e., if the angle θ between the rotation axis and the straight line defined above satisfies 40° [symbol] θ′ [symbol] 80°.

Note that since the arrangement of the slow axis of the phase plate 120 and the transmission axis of the polarization plate 130 in the reflective liquid crystal display device 100 of the present invention is different from that of conventional devices, the retardation of the phase plate 120 may also be different from that of conventional devices. This is because the value of the retardation to be given by a phase plate to linearly-polarized light is dependent on the relationship between the polarization direction of the linearly-polarized light and the slow axis of the phase plate.

Where the angle θ between the slow axis of the phase plate 120 and the absorption axis of the polarization plate 130 satisfies 20° [symbol] θ [symbol] 40°, it is preferred that the in-plane retardation Re(λ) of the phase plate 120 for light having a wavelength of λ (nm) satisfies 98 nm≦Re(450)≦158 nm, 140 nm≦Re(550)≦175 nm and 141 nm≦Re(650)≦210 nm, for example.

Note that the phase plate 120 is not limited to those having a uniaxial optical anisotropy. It is only required that the phase plate 120 has a retardation at least in the in-plane direction, and it may have a retardation in the normal direction. Although the retardation in the normal direction influences the viewing angle characteristics, etc., it does not have to be taken into consideration herein. Therefore, the phase plate 120 may alternatively be a phase plate having a biaxial optical anisotropy.

As described above, in the reflective liquid crystal display device 100, the slow axis of the phase plate 120 is inclined from a direction that is at an angle of 45° with respect to the transmission axis of the polarization plate 130, whereby a deviation in the angle of rotation for different wavelengths is less likely reflected in variations in the transmittance. Coloring can be suppressed more effectively if the in-plane retardation Re of the phase plate 120 has wavelength dependence such that there is only a small deviation in the angle of rotation for different wavelengths. More specifically, it is preferred that the in-plane retardation Re(λ) of the phase plate 120 for light having a wavelength of λ (nm) has wavelength dependence such that Re(λ)/λ is substantially constant over the range of 400 nm≦λ≦700 nm, and it is preferred that the in-plane retardation Re(λ) of the phase plate 120 increases monotonically as λ increases over the range of 400 nm≦λ≦700 nm. Moreover, it is preferred that the in-plane retardation Re(λ) of the phase plate 120 satisfies 0.7 [symbol] Re(450)/Re(550) [symbol] 0.9 and 1.01 [symbol] Re(650)/Re(550) [symbol] 1.2.

The phase plate 120 can be produced by using a method known in the art as a phase plate production method. In the reflective liquid crystal display device 100, since the slow axis of the phase plate 120 is inclined from a direction that is at an angle of 45° with respect to the transmission axis of the polarization plate 130, the slow axis of the phase plate 120 is typically inclined from the average orientation direction of the liquid crystal layer 108. The average orientation direction of the liquid crystal layer 108 is a direction defined by the azimuthal angle of the orientation direction of liquid crystal molecules present around the center of the liquid crystal layer 108 in the thickness direction thereof, and is the azimuthal direction in the middle between the orientation direction of liquid crystal molecules near the upper surface of the liquid crystal layer 108 (near the transparent electrode 105) and that of liquid crystal molecules near the lower surface of the liquid crystal layer 108 (near the reflection electrode 103). Therefore, the total retardation including the residual retardation Δn₁·d of the liquid crystal layer 108 and the in-plane retardation Re of the phase plate 120 cannot be expressed as a simple arithmetic sum (or difference) therebetween. However, once the arrangement of the slow axis of the phase plate 120 is determined, the in-plane retardation value required can be calculated based on the arrangement of the slow axis.

Next, a more specific example of the reflective liquid crystal display device 100 and display characteristics thereof will be described.

In the illustrated example, the in-plane retardation Re(550) of the phase plate 120 is 155 nm for light having a wavelength of 550 nm. As shown in FIG. 10, the angle between the slow axis of the phase plate 120 and the absorption axis of the polarization plate 130 is 33°, and the angle between the slow axis of the phase plate 120 and the average orientation direction of the liquid crystal layer 108 is 57°. The liquid crystal layer 108 is a liquid crystal layer of a homogeneous orientation type having a thickness of 5 μm. The retardation Δn₁·d of the liquid crystal layer 108 in a black display is about 28 nm, and retardation Δn₂·d of the liquid crystal layer 108 in a white display is about 164 nm.

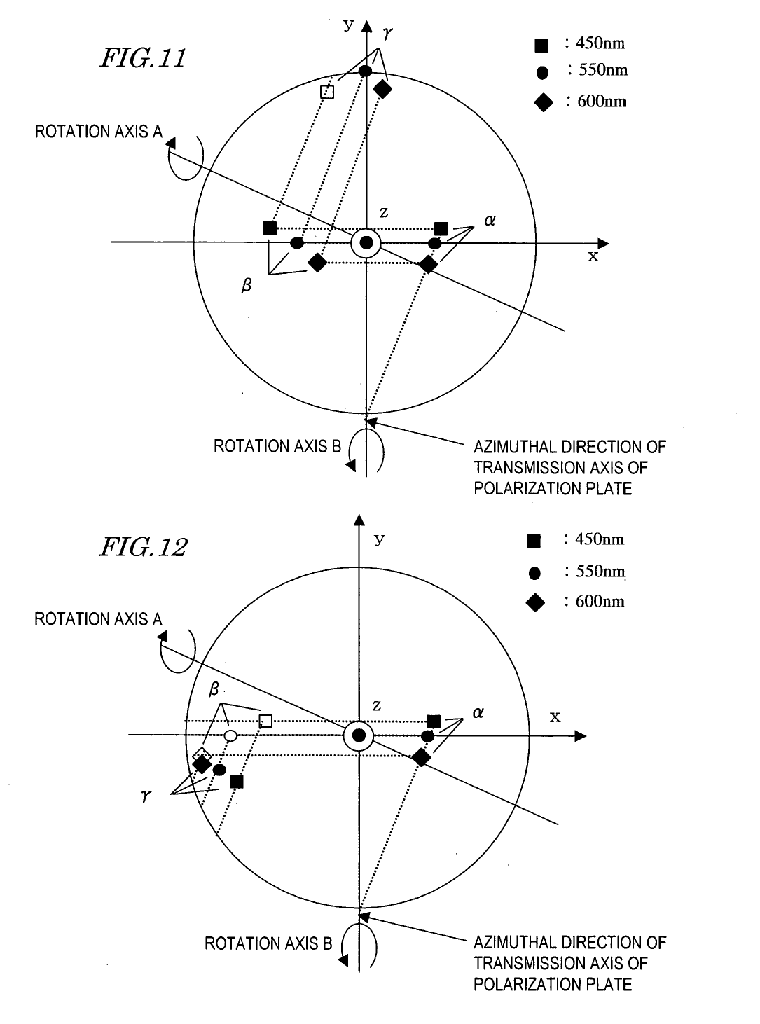

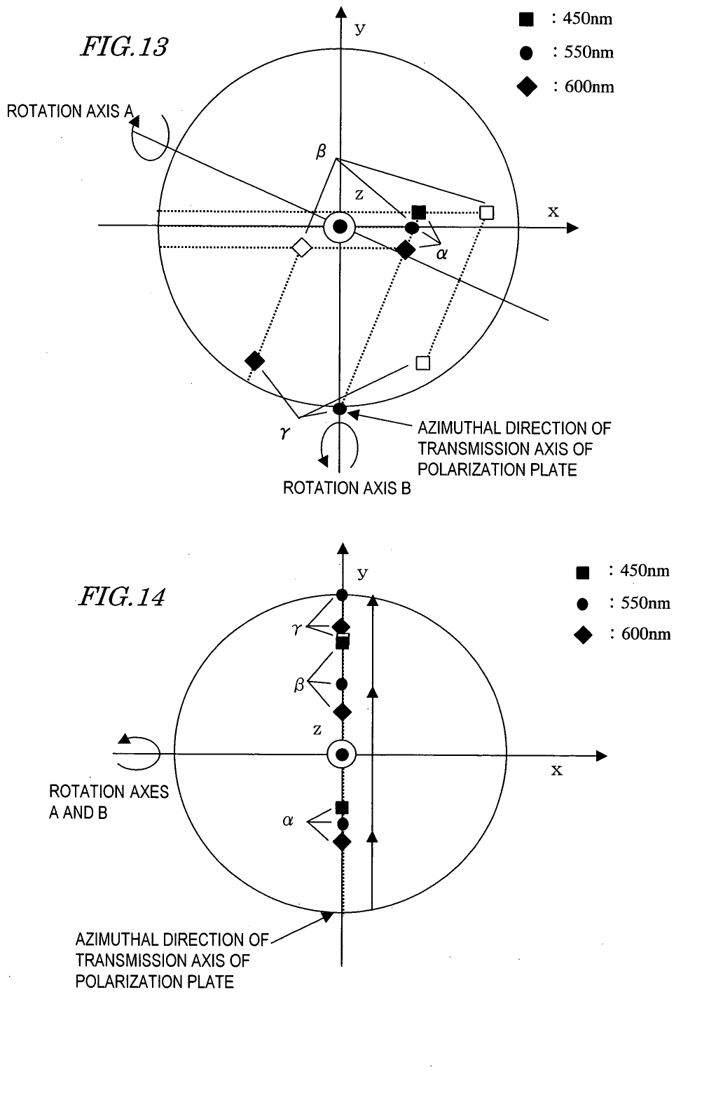

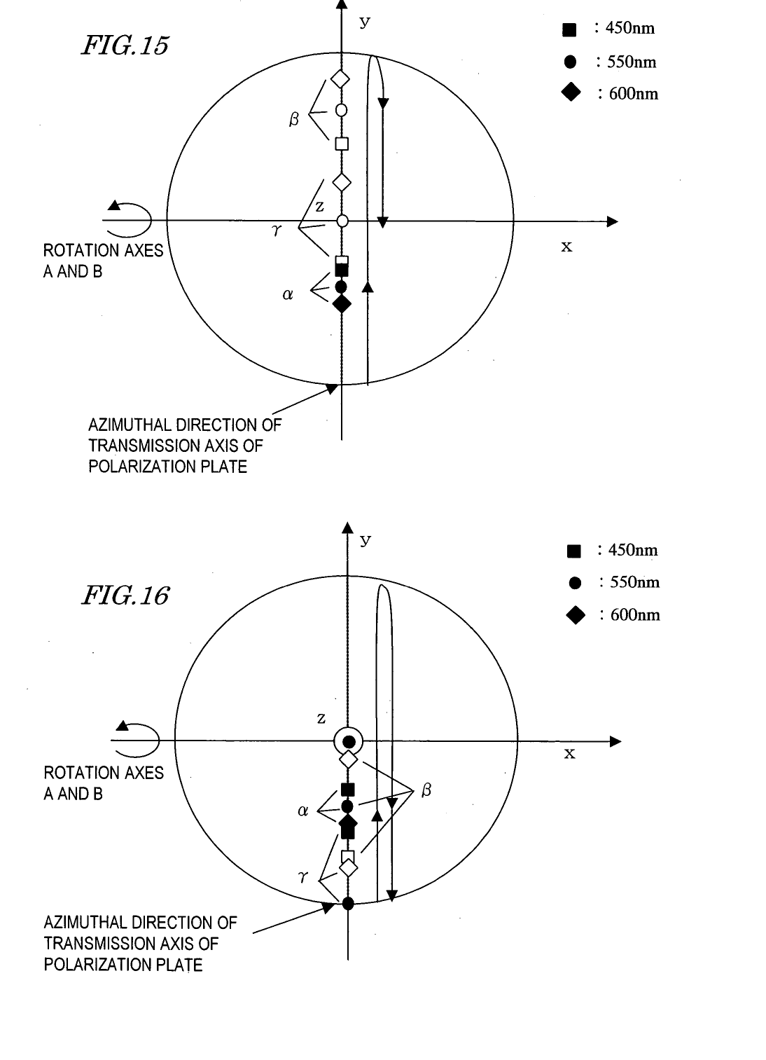

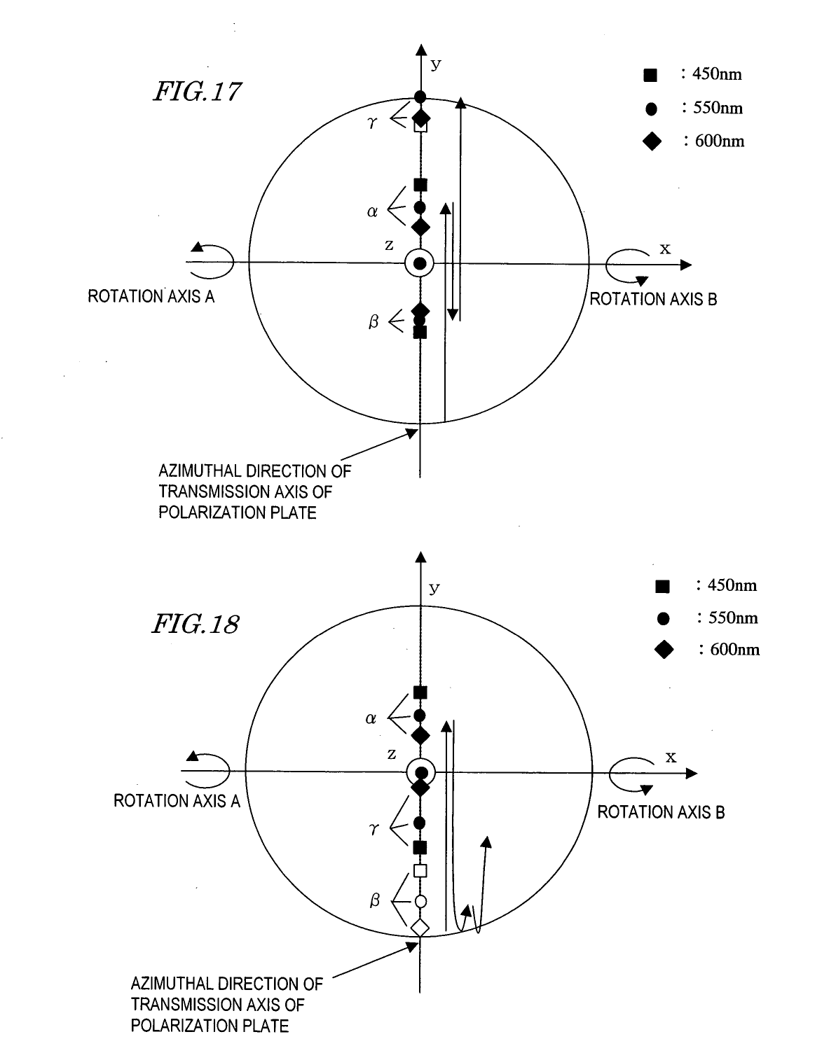

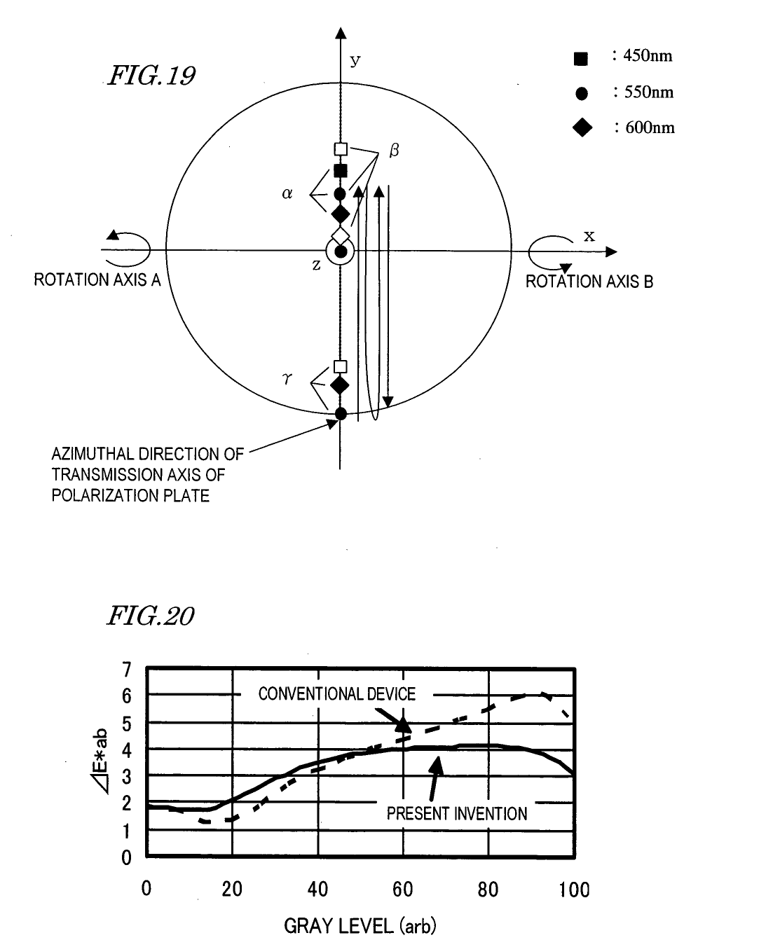

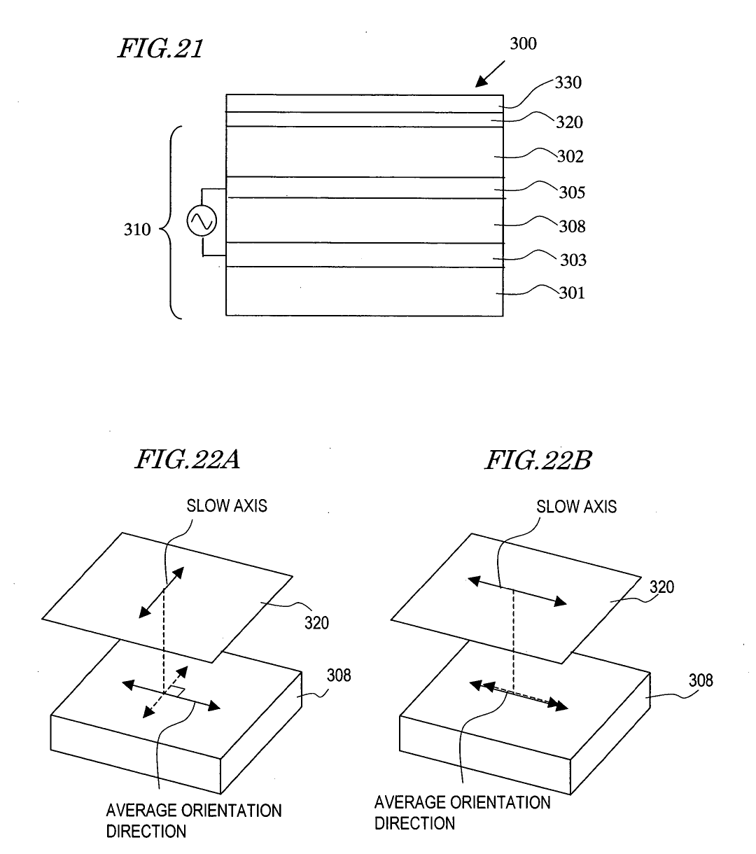

FIG. 11, FIG. 12 and FIG. 13 show how the polarization of incident light changes with this exemplary arrangement. FIG. 11 is for a black display, FIG. 12 an intermediate gray level display, and FIG. 13 a white display. As comparative examples, FIG. 14, FIG. 15 and FIG. 16 show how the polarization of incident light changes in a case where the slow axis of the phase plate and the average orientation direction of the liquid crystal layer are parallel to each other as illustrated in FIG. 22B, and FIG. 17, FIG. 18 and FIG. 19 show how the polarization of incident light changes in a case where the slow axis of the phase plate and the average orientation direction of the liquid crystal layer are perpendicular to each other as illustrated in FIG. 22A. FIG. 14 and FIG. 17 are for a black display, FIG. 15 and FIG. 18 an intermediate gray level display, and FIG. 16 and FIG. 19 a white display.

As can be seen by comparing these figures with one another, the reflective liquid crystal display device 100 of the present invention has less significant variations in the transmittance (variations of light denoted by “γ” in the y axis direction) in a black display and in an intermediate gray level display, indicating that coloring is suppressed, as compared with the conventional arrangements. It can be seen that the present invention is particularly effective in reducing variations in the transmittance, and thus suppressing coloring, in an intermediate gray level display.

One index of the degree of coloring is the color difference ΔE*ab in the L*a*b* color system from light of standard illuminant D65 (standard illuminant having substantially the same color temperature as sunlight). FIG. 20 shows simulated results of the color difference ΔE*ab between light from standard illuminant D65 and light output from the reflective liquid crystal display device 100 having an arrangement as shown in FIG. 10, and the color difference ΔE*ab between light from standard illuminant D65 and light output from a liquid crystal display device having the conventional arrangement for which FIG. 17 to FIG. 19 show how the polarization of incident light changes. As can be seen from FIG. 20, in the reflective liquid crystal display device 100 of the present embodiment, the color difference ΔE*ab is 5 or less for all gray levels, indicating a strong effect in suppressing coloring particularly in an intermediate gray level display.

Note that although coloring is suppressed in a black display and in an intermediate gray level display according to the present invention, a white display may appear slightly yellowish depending on the specifications of the liquid crystal display device. In such a case, a polarization plate that transmits slightly more light in the blue wavelength range than light of other wavelengths can be used to shift the overall color tone toward blue, thus preventing a white display from becoming yellowish. Moreover, with such a polarization plate, the color tone in an intermediate gray level (which may become slightly purpled) can also be shifted toward blue, thereby lessening redness to realize a color tone that is more natural to human eyes.

The present invention provides a liquid crystal display device that can be produced at a low cost and in which coloring in a black display and in an intermediate gray level display is sufficiently suppressed.

The present invention can widely be used in various liquid crystal display devices in which each pixel region corresponding to the minimum unit of display includes a reflection region where a display is produced in a reflection mode. For example, the present invention can be used in a transflective liquid crystal display device or a semi-transmissive liquid crystal display device using a semi-transmissive film (half mirror).

While the present invention has been described in a preferred embodiment, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

This non-provisional application claims priority under 35 USC § 119(a) on Patent Application No. 2003-326531 filed in Japan on Sep. 18, 2003, the entire contents of which are hereby incorporated by reference.

1. A liquid crystal display device, comprising:
a liquid crystal layer;
a first substrate and a second substrate opposing each other with the liquid crystal layer being interposed therebetween;
a reflection layer provided on one side of the liquid crystal layer that is closer to the first substrate;
a polarizer provided on one side of the liquid crystal layer that is closer to the second substrate;
a phase compensator provided between the liquid crystal layer and the polarizer and having a slow axis within a plane parallel to the liquid crystal layer; and
at least a pair of electrodes for applying a voltage across the liquid crystal layer, wherein:
the liquid crystal display device includes a reflection region in which a display is produced by using light that enters the device from one side of the device that is closer to the second substrate, passes through the polarizer, the phase compensator and the liquid crystal layer in this order and is reflected by the reflection layer; and
the slow axis of the phase compensator is inclined from a direction that is at an angle of 45° with respect to a transmission axis of the polarizer.

2. The liquid crystal display device according to claim 1, comprising no phase compensator other than the phase compensator.

3. The liquid crystal display device according to claim 1, wherein the phase compensator is a single phase plate.

4. The liquid crystal display device according to claim 1, wherein the slow axis of the phase compensator is inclined from a direction that is defined by an azimuthal angle of an orientation direction of liquid crystal molecules present around a center of the liquid crystal layer in a thickness direction thereof.

5. The liquid crystal display device according to claim 1, wherein an angle θ between the slow axis of the phase compensator and an absorption axis of the polarizer satisfies 20° [symbol] θ [symbol] 40°.

6. The liquid crystal display device according to claim 5, wherein an in-plane retardation Re(λ) of the phase compensator for light having a wavelength of λ (nm) satisfies 98 nm≦Re(450)≦158 nm, 140 nm≦Re(550)≦175 nm and 141 nm≦Re(650)≦210 nm.

7. The liquid crystal display device according to claim 1, wherein an in-plane retardation Re(λ) of the phase compensator for light having a wavelength of λ (nm) satisfies 0.7 [symbol] Re(450)/Re(550) [symbol] 0.9 and 1.01 [symbol] Re(650)/Re(550) [symbol] 1.2.

8. The liquid crystal display device according to claim 1, wherein an in-plane retardation Re(λ) of the phase compensator for light having a wavelength of λ (nm) increases monotonically as A increases over a range of 400 nm≦λ≦700 nm.

9. The liquid crystal display device according to claim 1, wherein a retardation Δn·d defined as a product of a birefringence Δn of the liquid crystal layer and a thickness d of the liquid crystal layer in the reflection region varies over a range of Δn₁·d≦Δn·d≦Δn₂·d according to a value of a voltage applied between the pair of electrodes, where a black display is produced when Δn·d=Δn₁·d.

10. The liquid crystal display device according to claim 1, wherein a color difference ΔE*ab in an L*a*b* color system between light from standard illuminant D65 and light being output from the polarizer toward a viewer after being reflected by the reflection layer is 5 or less.

11. A liquid crystal display device, comprising:
a liquid crystal layer;
a first substrate and a second substrate opposing each other with the liquid crystal layer being interposed therebetween;
a reflection layer provided on one side of the liquid crystal layer that is closer to the first substrate;
a polarizer provided on one side of the liquid crystal layer that is closer to the second substrate;
a phase compensator provided between the liquid crystal layer and the polarizer; and
at least a pair of electrodes for applying a voltage across the liquid crystal layer, wherein:
the liquid crystal display device includes a reflection region in which a display is produced by using light that enters the device from one side of the device that is closer to the second substrate, passes through the polarizer, the phase compensator and the liquid crystal layer in this order and is reflected by the reflection layer; and
the phase compensator rotates, on a Poincare sphere, linearly-polarized light, having entered the device from one side of the device that is closer to the second substrate and passed through the polarizer, about a rotation axis inclined from a straight line including a point on the Poincare sphere representing the linearly-polarized light and a center of the Poincare sphere.

12. The liquid crystal display device according to claim 11, wherein an angle θ′ between the rotation axis and the straight line satisfies 40° [symbol] θ′ [symbol] 80°.

13. The liquid crystal display device according to claim 11, wherein a retardation Δn·d defined as a product of a birefringence Δn of the liquid crystal layer and a thickness d of the liquid crystal layer in the reflection region varies over a range of Δn₁·d≦Δn·d≦Δn₂·d according to a value of a voltage applied between the pair of electrodes, where a black display is produced when Δn·d=Δn₁·d.

14. The liquid crystal display device according to claim 11, wherein a color difference ΔE*ab in an L*a*b* color system between light from standard illuminant D65 and light being output from the polarizer toward a viewer after being reflected by the reflection layer is 5 or less.
